(19) United States
(12) Patent Application Publication
(10) Pub. No.: US 2026/0298269 A1
(43) Pub. Date: Oct. 1, 2026

(54) Indexing Compensation Fastener

(71) Applicant: Illinois Tool Works Inc., Glenview, IL (US)

(72) Inventors: Victoria Brender, Gaylord, MI (US); Mark Beyer, Armada, MI (US)

(21) Appl. No.: 19/569,123

(22) Filed: Mar. 17, 2026

Related U.S. Application Data
(60) Provisional application No. 63/781,761, filed on Apr. 1, 2025.

(51) Int. Cl. F16B 5/02; F16B 33/00

(52) U.S. Cl. CPC F16B 5/025; F16B 5/0233; F16B 33/002

(57) ABSTRACT

A compensation fastener assembly includes a threaded insert and a threaded collar that are threadably engaged so that rotation between the components causes axial movement. An indexing feature is positioned between the threaded insert and the threaded collar and engages a cooperating surface to define a plurality of indexed rotational positions. The indexing feature resists unintended rotation between the threaded components so that the assembly can be set to a selected height and maintained in that position prior to installation. In some examples, the indexing feature includes an indexing ring having detents that engage a leading end of the threaded insert. In other examples, the indexing feature is formed as a resilient finger, integrally formed with the threaded collar.

### RELATED APPLICATION

The present application claims priority to U.S. Provisional Patent Application No. 63/781,761, filed Apr. 1, 2025, and entitled “Indexing Compensation Fastener,” which is hereby incorporated by reference in its entirety.

### BACKGROUND

Automotive components commonly utilize fastening systems to secure one component to another. Such fastening systems are generally designed to be straightforward to manufacture and assemble while providing reliable retention during use. In many applications, dimensional variations may occur between mating components as a result of manufacturing tolerances, material properties, thermal effects, or assembly conditions. Accordingly, fastening systems are sometimes configured to accommodate such variations.

In certain arrangements, spring clips or other resilient fastening elements may be used to compensate for tolerances between components and, in some cases, within the fastening device itself. For example, tolerance compensation devices may include a base element configured to be mounted to a first component and a compensation element that is threadingly engaged with the base element. Such configurations may permit relative movement between the elements to accommodate dimensional variation during assembly.

Fastening or tolerance compensation assemblies may also incorporate components formed from different materials in order to achieve desired performance or manufacturing characteristics. For instance, metal elements may provide structural strength, durability, and resilient fastening properties, while polymeric components, such as plastic housings, may facilitate modularity, reduced weight, and integration with a variety of mounting environments. In some implementations, a modular housing may permit common metal fastening elements to be used across different applications.

However, during manufacturing, packaging, shipment, or pre-installation handling, components of such fastening assemblies may move relative to one another, which may result in the assembly not being maintained in a desired configuration prior to installation. Accordingly, there remains a need for a fastening assembly that includes an indexing feature configured to allow the fastening assembly to be set and maintained in a desired position prior to shipment.

### SUMMARY

The present disclosure relates generally to a compensation fastener assembly, substantially as illustrated by and described in connection with at least one of the figures, as set forth more completely in the claims. More particularly, to an indexing compensation fastener assembly.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a side elevation assembly view of a fastener-retaining system having a compensation fastener assembly in accordance with an aspect of this disclosure.

FIG. 2a illustrates an assembled isometric view of the compensation fastener assembly of FIG. 1.

FIG. 2b illustrates an assembly isometric view of the compensation fastener assembly of FIG. 1.

FIG. 2c illustrates a bottom plan view of the compensation fastener assembly of FIG. 1 in a first axial position associated with a first indexed position.

FIG. 2d illustrates a bottom plan view of the compensation fastener assembly of FIG. 1 in a second axial position associated with an intermediate position.

FIG. 2e illustrates a bottom plan view of the compensation fastener assembly of FIG. 1 in a third axial position associated with a second indexed position.

FIG. 2f illustrates an assembled cross-sectional view of the compensation fastener assembly taken along cutline A-A in FIG. 2a.

FIG. 2g illustrates an assembled cross-sectional view of the compensation fastener assembly taken along cutline B-B in FIG. 2a.

FIGS. 3a and 3b illustrate, respectively, isometric and cross-sectional views of the threaded collar of the compensation fastener assembly of FIG. 1.

FIGS. 3c and 3d illustrate, respectively, first and second side elevation views of the threaded collar of the compensation fastener assembly of FIG. 1.

FIGS. 4a, 4b, and 4c illustrate, respectively, isometric, top plan, and bottom plan views of the threaded insert of the compensation fastener assembly of FIG. 1 having a generally square leading end.

FIGS. 5a, 5b, and 5c illustrate, respectively, isometric, top plan, and bottom plan views of the threaded insert in accordance with another aspect having a generally triangular leading end.

FIGS. 6a, 6b, and 6c illustrate, respectively, isometric, top plan, and bottom plan views of the threaded insert in accordance with yet another aspect having a generally hexagonal leading end.

FIGS. 7a, 7b, and 7c illustrate, respectively, isometric, top plan, and bottom plan views of the threaded insert in accordance with yet another aspect having a generally oval leading end.

FIGS. 8a and 8b illustrate, respectively, isometric and top plan views of an indexing ring of the compensation fastener assembly of FIG. 1.

FIGS. 9a and 9b illustrate, respectively, isometric and top plan views of an indexing ring in accordance with another aspect.

FIGS. 10a and 10b illustrate, respectively, isometric and cross-sectional views of the threaded collar of the compensation fastener assembly in accordance with another aspect having an integrated indexing feature.

FIGS. 10c and 10d illustrate, respectively, first and second side elevation views of the threaded collar of the compensation fastener assembly of FIGS. 10a and 10b.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

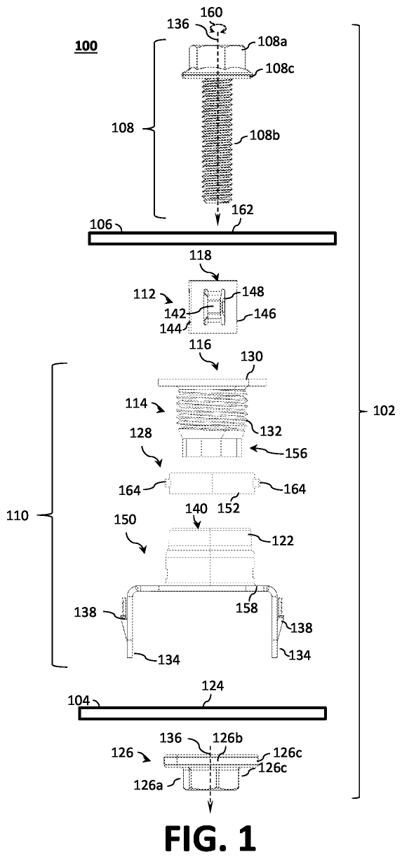

The present disclosure provides a compensation fastener assembly for use in a fastener-retaining system where the compensation fastener assembly includes an indexing feature configured to allow the compensation fastener assembly to be set to a desired position (e.g., to a desired height) and maintained at the desired position prior to, and during, shipment and handling. The indexing feature further prevents or substantially mitigates unintended relative rotation between cooperating threaded components of the compensation fastener assembly once the desired position has been established. FIGS. 1 through 10d illustrate various aspects of a fastener-retaining system 100 including a compensation fastener assembly 110.

In some aspects, a compensation fastener assembly may include a threaded insert having external threads and a leading end, and a threaded collar defining a threaded passageway having internal threads configured to threadably engage the external threads of the threaded insert such that rotation of the threaded insert relative to the threaded collar about a central longitudinal axis causes axial movement between the threaded insert and the threaded collar. The compensation fastener assembly may further include an indexing feature disposed between the threaded insert and the threaded collar and configured to engage the leading end of the threaded insert. The indexing feature and the leading end may cooperate to define a plurality of indexed rotational positions between the threaded insert and the threaded collar about the central longitudinal axis. Engagement between the indexing feature and the leading end may rotationally retain the threaded insert relative to the threaded collar in at least one of the indexed rotational positions to prevent or substantially mitigate unintended relative rotation between the threaded insert and the threaded collar.

In some aspects of the compensation fastener assembly, the indexing feature may comprise an indexing ring positioned between the threaded insert and the threaded collar.

In some aspects, the indexing ring may comprise an annular body having a plurality of outwardly extending tabs configured to engage corresponding retainer openings formed in the threaded collar.

In some aspects, the indexing ring may comprise a plurality of inwardly extending indexing detents configured to engage the leading end of the threaded insert.

In some aspects, the indexing detents may selectively engage portions of the leading end during rotation of the threaded insert relative to the threaded collar.

In some aspects, the leading end of the threaded insert may define a plurality of corners and a plurality of flat regions arranged circumferentially about the central longitudinal axis.

In some aspects, the indexing feature may be configured to engage the flat regions to define the indexed rotational positions.

In some aspects, each indexing detent may include a first leg and a second leg, the second leg being steeper than the first leg and configured to resist counter-rotation of the threaded insert relative to the threaded collar.

In some aspects, the indexing feature may comprise a resilient finger formed from the threaded collar and extending inwardly toward the central longitudinal axis to engage the leading end of the threaded insert.

In some aspects, a threaded fastener assembly comprising cooperating threaded components may include a first threaded component and a second threaded component threadably engaged with the first threaded component such that relative rotation between the first threaded component and the second threaded component produces axial movement between the components. The threaded fastener assembly may further include a rotational indexing interface disposed between the first threaded component and the second threaded component. The rotational indexing interface may include at least one resilient indexing element and at least one cooperating engagement surface defined by one of the threaded components. The indexing element may be configured to elastically deflect during relative rotation of the threaded components and to engage the cooperating engagement surface to establish a plurality of discrete rotational positions between the threaded components. Engagement between the indexing element and the cooperating engagement surface may resist unintended relative rotation between the threaded components.

In some aspects, the rotational indexing interface may include a ring positioned between the threaded components.

In some aspects, the indexing element may comprise a detent configured to engage alternating corner regions and flat regions defined by the cooperating engagement surface.

In some aspects, the indexing element may comprise a resilient finger integrally formed from one of the threaded components.

In some aspects, the cooperating engagement surface may define a polygonal perimeter.

In some aspects, the polygonal perimeter may be selected from a triangular profile, a square profile, or a hexagonal profile.

In some aspects, the cooperating engagement surface may define an oval perimeter configured to provide two indexed rotational positions during a complete rotation.

In some aspects, a fastener-retaining system may include a first component, a second component, a fastener configured to extend through the first component toward the second component, and a compensation fastener assembly positioned adjacent the first component and configured to receive the fastener. The compensation fastener assembly may include a threaded insert having external threads and a leading end, a threaded collar defining a threaded passageway having internal threads configured to threadably engage the external threads of the threaded insert such that rotation of the threaded insert relative to the threaded collar about a central longitudinal axis causes axial movement between the threaded insert and the threaded collar, and an indexing feature disposed between the threaded insert and the threaded collar and configured to engage the leading end of the threaded insert. The indexing feature and the leading end may cooperate to define a plurality of indexed rotational positions between the threaded insert and the threaded collar about the central longitudinal axis, and engagement between the indexing feature and the leading end may rotationally retain the threaded insert relative to the threaded collar in at least one of the indexed rotational positions to prevent or substantially mitigate unintended relative rotation between the threaded insert and the threaded collar. The compensation fastener assembly may be adjustable in height through rotation of the threaded insert relative to the threaded collar, and the indexing feature may maintain the threaded insert in a selected axial position relative to the threaded collar prior to installation of the fastener.

In some aspects, the fastener-retaining system may further include a spring clip positioned within a sleeve through-hole of the threaded insert.

In some aspects, the spring clip may include resilient tabs configured to frictionally retain the fastener within the compensation fastener assembly.

In some aspects, the threaded collar may include at least one resilient leg configured to engage an opening formed in the first component.

FIG. 1 illustrates a side elevation assembly view of the fastener-retaining system 100 including the compensation fastener assembly 110. The fastener-retaining system 100 includes a fastener assembly 102 configured to couple a first component 104 relative to a second component 106 via a fastener 108 and an indexing compensating assembly 110 having a spring clip 112.

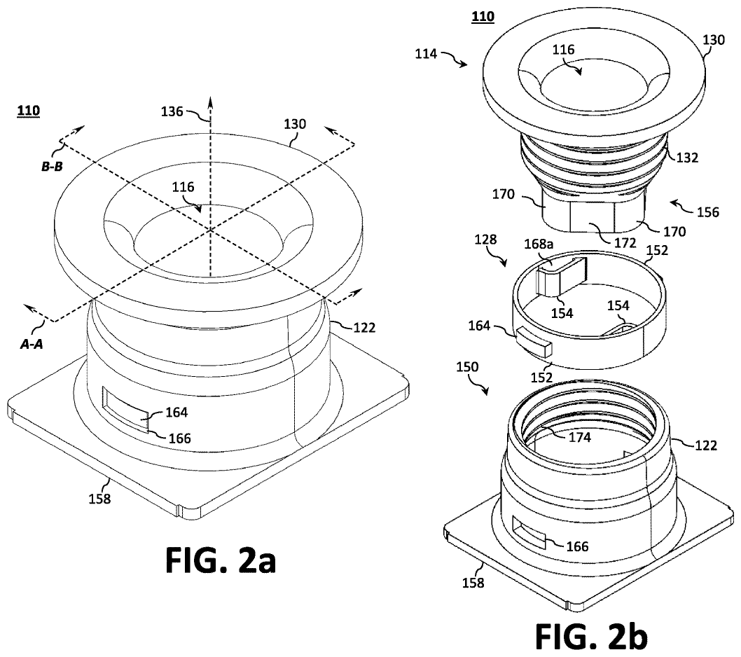

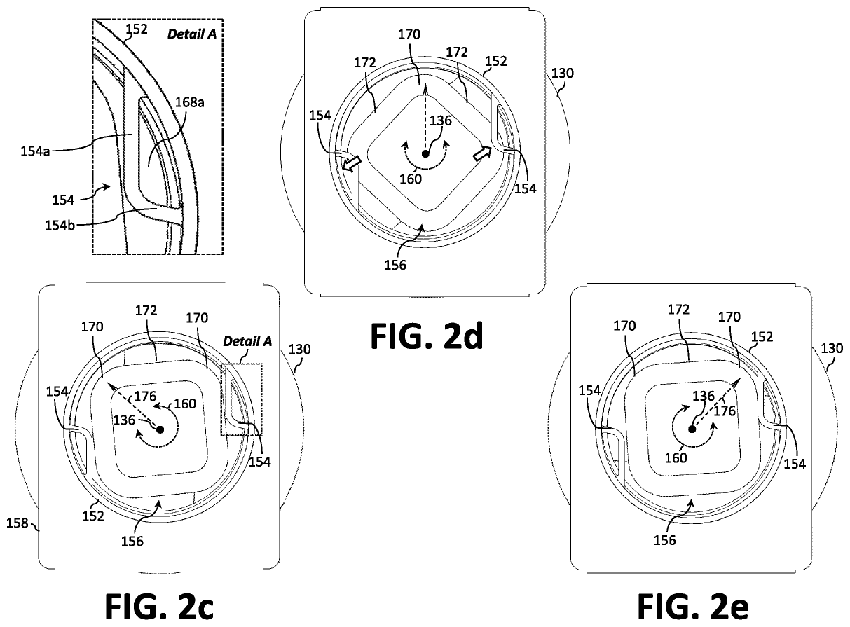

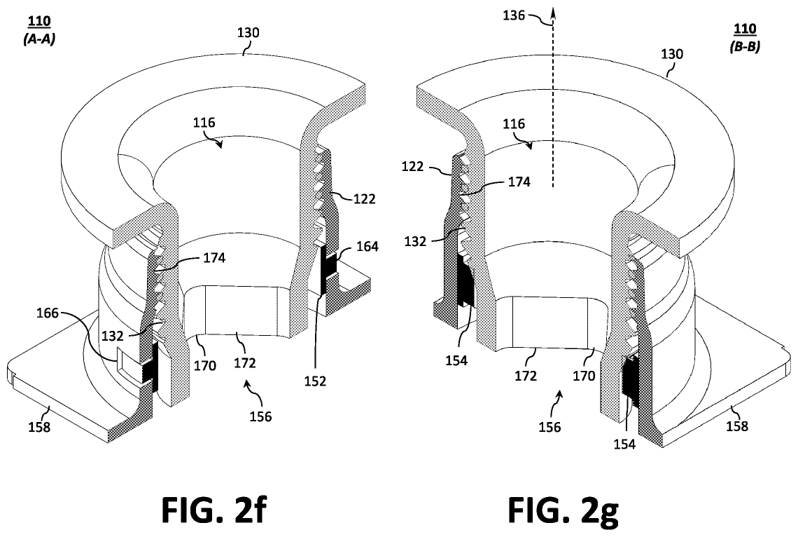

The indexing compensating assembly 110 is illustrated in greater detail with reference to FIGS. 2a through 2g. FIG. 2a illustrates an assembled isometric view of the compensation fastener assembly 110. FIG. 2b illustrates an assembly isometric view of the compensation fastener assembly 110. FIG. 2c illustrates a bottom plan view of the compensation fastener assembly 110 in a first axial position associated with a first indexed position. FIG. 2d illustrates a bottom plan view of the compensation fastener assembly 110 in a second axial position associated with an intermediate position. FIG. 2e illustrates a bottom plan view of the compensation fastener assembly 110 in a third axial position associated with a second indexed position. FIG. 2f illustrates an assembled cross-sectional view of the compensation fastener assembly 110 taken along cutline A-A in FIG. 2a. FIG. 2g illustrates an assembled cross-sectional view of the compensation fastener assembly 110 taken along cutline B-B in FIG. 2a.

The illustrated fastener-retaining system 100 includes a first component 104, a second component 106, and a fastener assembly 102. The fastener assembly 102 is configured to join the first component 104 and the second component 106 while compensating for tolerances between the first component 104 and the second component 106. In this example, the fastener assembly 102 generally comprises a fastener 108, a spring clip 112, and an indexing compensating assembly 110. The fastener assembly 102 can be used with, for example, the first component 104 in the form of a panel or sheet of metal having one or more openings 124 (or cutouts) (e.g., a center hole and clip leg openings) to receive and secure the indexing compensating assembly 110, and a second component 106 having an opening 162 to receive the fastener 108 (e.g., a round hole).

The fastener 108 is illustrated as a male fastener (e.g., a head 108a connected to a collar 108c with an externally threaded shank 108b) configured to engage a female fastener (e.g., an internally threaded component such as a threaded collar, threaded opening, or a nut 126). The fastener 108 may be a bolt, for example. At least a portion of the shank 108b is externally threaded. The shank 108b is coaxial with the head 108a and the collar 108c. In the illustrated example, the male fastener 108 is a threaded bolt with a hex-shaped head, although other types of fasteners and fastener heads are contemplated. The shank 108b of the fastener 108 passes through the indexing compensating assembly 110 (e.g., via a passageway 118 of the spring clip 112). While the fastener 108 is illustrated as a bolt, a stud or similar component can be used in lieu of the bolt. In this example, the nut 126 is a flanged nut having a nut body 126a (e.g., a hex-shaped body), a threaded hole 126b, and a nut flange 126c.

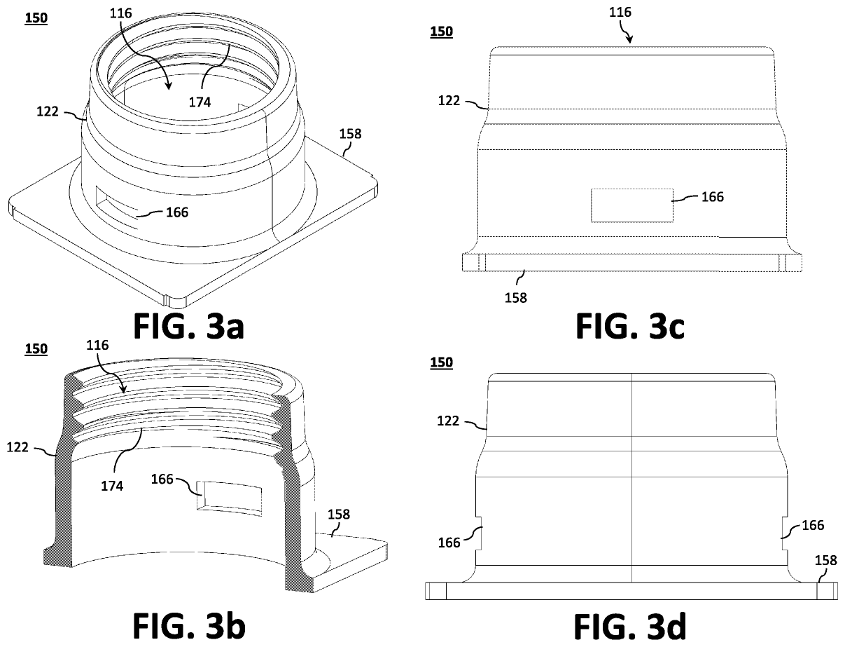

The indexing compensating assembly 110 is illustrated as a multi-component retainer clip assembly comprising a threaded insert 114, a threaded collar 150, and an indexing ring 128. FIGS. 3a and 3b illustrate, respectively, isometric and cross-sectional views of the threaded collar 150 of the compensation fastener assembly of FIG. 1, while FIGS. 3c and 3d illustrate, respectively, first and second side elevation views of the threaded collar 150. When assembled, the threaded insert 114 and the threaded collar 150 are configured to engage one another with the indexing ring 128 positioned therebetween. The threaded insert 114 and the threaded collar 150 are configured to rotate relative to one another about a central longitudinal axis 136 as indicated by rotation arrow 160 to adjust the distance between the first component 104 and the second component 106 once assembled. Rotating the threaded insert 114 in a first direction increases the distance while rotating the threaded insert 114 in a second direction decreases the distance. Each of the threaded insert 114 and the threaded collar 150 can be fabricated as a stamped-metal component, for example, while the indexing ring 128 can be formed from a plastic material.

In general terms, the threaded insert 114 and the threaded collar 150 represent cooperating threaded components that are threadably engaged with one another. The cooperating threaded components are configured such that relative rotation between the components about the central longitudinal axis 136 produces corresponding axial movement between the components due to the threaded engagement. The compensation fastener assembly 110 serves as a threaded fastener assembly having cooperating threaded components that define an adjustable axial relationship.

To control the relative rotational relationship between the cooperating threaded components, the compensation fastener assembly 110 further includes an indexing feature configured to provide a rotational indexing interface between the threaded insert 114 and the threaded collar 150. The rotational indexing interface defines a plurality of discrete rotational positions between the threaded components and resists unintended rotation about the central longitudinal axis 136 between the components. In this manner, the compensation fastener assembly 110 can be adjusted to a desired axial height and maintained at that height prior to installation of the fastener assembly.

The indexing ring 128 serves as an interface between the leading end 156 of the threaded insert 114 and the threaded collar 150. The indexing ring 128 comprises a generally annular body 152. Extending outwardly from the annular body 152 are a plurality of tabs 164 sized and shaped to be positioned within retainer openings 166 formed in the threaded collar 150. In operation, the indexing ring 128 can be pre-installed in the threaded collar 150 and retained in place via the interaction between the plurality of tabs 164 and their corresponding retainer openings 166. While tabs 164 and retainer openings 166 are shown, other techniques for securing the indexing ring 128 to the threaded collar 150 are contemplated, including the use of adhesives, friction fit, a non-annular ring configuration (e.g., a square ring), or other retention arrangements.

Extending inwardly from the annular body 152 are a plurality of indexing detents 154. The indexing detents 154 are sized and shaped to interact with the leading end 156 of the threaded insert 114, such as the corners 170 of a bottom outer surface of the leading end 156. While two indexing detents 154 are illustrated, additional or fewer may be employed depending on, for example, the shape of the leading end 156 and/or the desired number of index positions.

In this manner, the indexing detents 154 function as resilient indexing elements that cooperate with a cooperating engagement surface defined by the leading end 156 of the threaded insert 114. The interaction between the indexing elements and the cooperating engagement surface forms a rotational indexing interface that establishes discrete rotational positions between the threaded insert 114 and the threaded collar 150 about the central longitudinal axis 136.

With reference to FIGS. 2c through 2e, the interaction between the indexing detents 154 and the leading end 156 is illustrated. An orientation arrow 176 is provided to illustrate the rotational position of the threaded insert 114 relative to the threaded collar 150.

Starting with FIG. 2c, the threaded insert 114 is positioned relative to the threaded collar 150 such that the plurality of indexing detents 154 abut flat regions 172 of the leading end 156. In this indexed position, the engagement between the detents 154 and the flat regions 172 rotationally retains the threaded insert 114 relative to the threaded collar 150 about the central longitudinal axis 136. In the illustrated orientation, the orientation arrow 176 is directed toward a position approximately halfway between the 10 and 11 o'clock positions (about 335 degrees) around the central longitudinal axis 136.

Turning to FIG. 2d, the threaded insert 114 is rotated relative to the threaded collar 150 by about 45 degrees around the central longitudinal axis 136 as indicated by rotation arrow 160, such that the orientation arrow 176 is oriented toward the 12 o'clock position (about 0 degrees). In this position, the plurality of indexing detents 154 interact with the corners 170 of the leading end 156. The corners 170 act as camming surfaces that engage and elastically deflect the indexing detents 154 as indicated by the arrows as rotation continues. With sufficient torque application, the corners 170 can compress or otherwise overcome the indexing detents 154 to allow the threaded insert 114 to rotate further.

In FIG. 2e, the threaded insert 114 has rotated further such that the indexing detents 154 again abut flat regions 172 of the leading end 156, thereby establishing a second indexed rotational position. The process can be repeated until the threaded insert 114 and the threaded collar 150 define the desired height. Once an indexed position is reached, the interaction between the detents 154 and the flat regions 172 secures the threaded insert 114 relative to the threaded collar 150 and resists unintended rotation between the components. Here, the orientation arrow 176 is oriented toward a position approximately halfway between the 2 and 3 o'clock positions (about 45 degrees) around the central longitudinal axis 136.

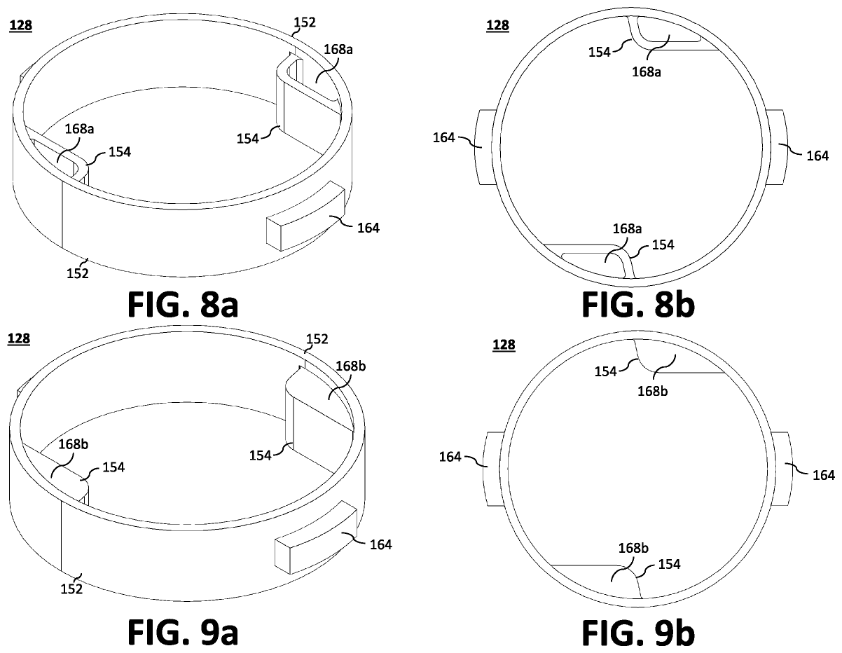

The indexing ring 128 is shown in greater detail in connection with FIGS. 8a and 8b. Each indexing detent 154 may be shaped with a first leg 154a and a second leg 154b. The slope of the first leg 154a is less than the slope of the second leg 154b, which reduces obstruction with the corners 170 during rotation in the adjustment direction. The steeper second leg 154b serves as a backstop to mitigate unwanted counter-rotation of the threaded insert 114 relative to the threaded collar 150.

In this example, the first leg 154a and the second leg 154b define a hollow center region 168a that allows the indexing detents 154 to deform more easily when the corners 170 pass the detents. Other examples are contemplated. For example, the center region may alternatively be configured as a solid center region 168b as illustrated in the example indexing ring 128 of FIGS. 9a and 9b. The solid center region 168b results in indexing detents 154 that are harder to compress and, therefore, required increased rotation force (torque) to transition between adjacent indexed rotational positions.

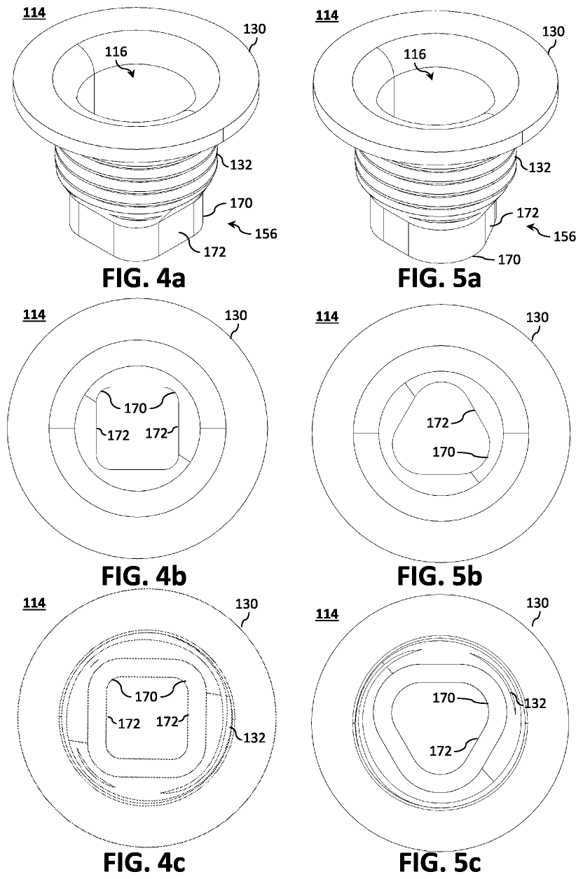

The leading end 156 defines a cross-sectional profile with a plurality of corners 170 and a plurality of flat regions 172. In the example illustrated in FIGS. 2a through 2g, the cross-sectional profile is generally square with rounded corners (i.e., a rounded square), as best illustrated in FIGS. 4a through 4c, which illustrate isometric, top plan, and bottom plan views of the threaded insert 114. The square profile includes four corners 170 and four flat regions 172, thereby providing four discrete indexing positions during a complete 360-degree rotation of the threaded insert 114 about the central longitudinal axis 136.

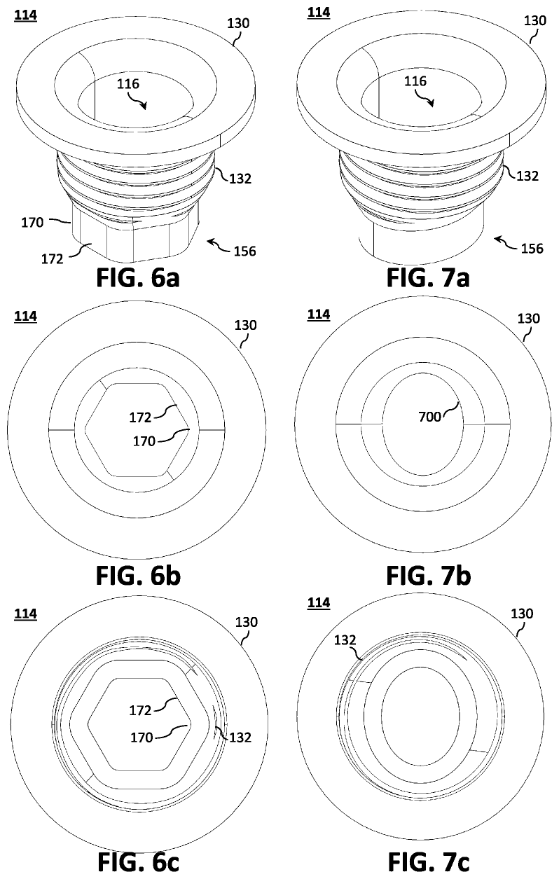

Alternative geometries are also contemplated. For example, FIGS. 5a through 5c illustrate a triangular profile having three corners 170 and three flat regions 172, thereby providing three indexed positions. FIGS. 6a through 6c illustrate a hexagonal profile having six corners 170 and six flat regions 172, thereby providing six indexed positions. In another example illustrated in FIGS. 7a through 7c, the leading end 156 may define a generally oval perimeter 700 rather than discrete corners and flat regions. In such arrangements, the varying curvature of the oval perimeter cooperates with the indexing elements to establish two discrete indexed positions during a complete rotation.

While the illustrated embodiments show indexing detents interacting with the leading end of the threaded insert, other indexing structures are contemplated. For example, the rotational indexing interface may include indexing elements in the form of resilient fingers, spring elements, projections, tabs, or other deformable structures capable of elastically deflecting during relative rotation of the threaded components.

Similarly, the cooperating engagement surface may be defined by other portions of the threaded components and may include flat surfaces, curved surfaces, polygonal surfaces, or other circumferential engagement features capable of interacting with the indexing elements to establish indexed rotational positions.

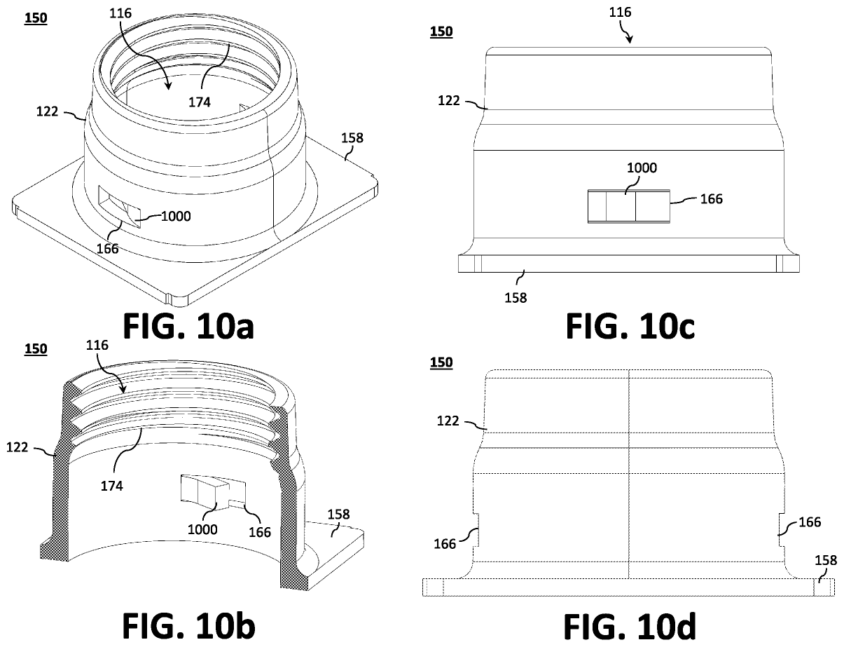

In some aspects, the indexing functionality may be integrated directly into the threaded collar 150 as illustrated in FIGS. 10a through 10d. In this configuration, the threaded collar 150 includes an integrated indexing feature 1000 formed by punching a portion of the collar material and bending the portion inwardly to form a resilient finger. The resilient finger extends toward the central longitudinal axis 136 and engages the leading end 156 of the threaded insert 114 in a manner similar to the indexing detents 154 described above.

Through this interaction, the resilient finger elastically deflects when engaged by the corners 170 of the threaded insert during rotation and subsequently returns toward its original position when aligned with a flat region 172. This interaction establishes discrete indexed rotational positions and resists unintended rotation between the threaded components.

Accordingly, the indexing functionality described herein may be implemented using a separate indexing component (e.g., the indexing ring 128) or using integrated indexing structures formed directly in one of the threaded components (e.g., the integrated indexing feature 1000).

The indexing structures described herein provide sufficient rotational resistance such that forces encountered during handling, shipping, packaging, or pre-installation movement are insufficient to cause unintended rotation between the threaded components. As a result, the compensation fastener assembly can be adjusted to a desired axial height and reliably maintained in that configuration prior to installation.

The threaded insert 114 generally comprises a flange 130 and a threaded body 132. The threaded body 132 is a tubular shaft having external threads and defining an interior sleeve through-hole 116 extending therethrough. The flange 130 may include one or more notches to facilitate manual or tool-based rotation.

The threaded collar 150 generally comprises a collar flange 158 and a threaded collar 122 defining a threaded passageway 140 with interior threading 174 configured to engage the threaded body 132 of the threaded insert 114. The collar flange 158 may include attachment features such as legs 134 having spring tabs 138 configured to engage openings in the first component 104. The pair of legs 134 resiliently coupled thereto and extending generally perpendicular to the collar flange 158. Each of the legs 134 includes one or more attachment features, such as the illustrated spring tabs 138. For example, each leg 134 may be stamped or otherwise shaped to form a pair of vertical post portions joined at their free ends by a horizontal bridge portion. In an example, the spring tabs 138 are positioned between and parallel to the vertical post portions and are resiliently coupled to the horizontal bridge portion.

In the example illustrated in FIG. 1, the attachment features are shown as legs 134 including spring tabs 138. It will be appreciated, however, that other attachment features may be used, including, for example, push pins, clips (e.g., W-clips, U-clips, etc.), mechanical fasteners (e.g., nuts, bolts, etc.), or other suitable coupling elements. Accordingly, the attachment features are omitted from FIGS. 2A-10D for clarity, as the indexing features described herein are not limited to any particular type or configuration of attachment feature.

The spring clip 112 comprises a cylindrical sidewall 146 having spring tabs 142 formed in windows 148. The spring clip 112 may frictionally retain the fastener 108 within the compensation fastener assembly prior to installation. The cylindrical sidewall 146 may further comprise a slot 144 that allows the cylindrical sidewall 146 to flex (e.g., move toward or away from the central longitudinal axis 136) during, for example, installation.

The compensation fastener assembly 110 may therefore be pre-assembled with the fastener 108 and installed into the first component 104 prior to final assembly with the second component 106.

The first component 104 and the second component 106 may be, for example, automotive panels or other automotive components. Depending on the application, one or both components may be fabricated from metal or metal alloys, synthetic or semi-synthetic polymers (e.g., acrylonitrile butadiene styrene (ABS), polyvinyl chloride (PVC)), composite materials (e.g., fiberglass), or combinations thereof. In the automotive industry, for example first components 104 include, without limitation, door trim panels, moldings, trim pieces, and other substrates used as interior or exterior surfaces. The second component 106 may be a frame, an automotive panel, or a structural vehicle component such as doors, pillars (e.g., A-pillar, B-pillar, C-pillar), dashboard components (e.g., cross members, brackets, frames), seat frames, center consoles, fenders, or sheet metal frameworks.

As noted, certain components of the fastener assembly 102 may be fabricated from metal materials using metal tubes and/or metal sheets via metal-drawing, metal-stamping, or other metal-forming techniques. For example, the spring clip 112, the threaded insert 114, and the threaded collar 150 may be formed through a metal-stamping and/or extrusion process. Other components of the indexing compensating assembly 110, such as the indexing ring 128, may be fabricated from plastic materials using plastic injection molding, additive manufacturing, or similar techniques. While the threaded insert 114 and the threaded collar 150 are described as metal components, it is contemplated that the threaded insert 114 could alternatively be formed from a plastic material while the threaded collar 150 remains a metal component.

It is also contemplated that components of the fastener assembly 102 could be fabricated using additive manufacturing techniques such as fused deposition modeling (FDM), stereolithography (SLA), selective laser sintering (SLS), material jetting, binder jetting, powder bed fusion, directed energy deposition, vat photopolymerization, or other suitable additive manufacturing processes.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A compensation fastener assembly, comprising:
a threaded insert having external threads and a leading end;
a threaded collar defining a threaded passageway having internal threads configured to threadably engage the external threads of the threaded insert such that rotation of the threaded insert relative to the threaded collar about a central longitudinal axis causes axial movement between the threaded insert and the threaded collar; and
an indexing feature disposed between the threaded insert and the threaded collar and configured to engage the leading end of the threaded insert,
wherein the indexing feature and the leading end cooperate to define a plurality of indexed rotational positions between the threaded insert and the threaded collar about the central longitudinal axis, and
wherein engagement between the indexing feature and the leading end rotationally retains the threaded insert relative to the threaded collar in at least one of the indexed rotational positions to prevent or substantially mitigate unintended relative rotation between the threaded insert and the threaded collar.

2. The compensation fastener assembly of claim 1, wherein the indexing feature comprises an indexing ring positioned between the threaded insert and the threaded collar.

3. The compensation fastener assembly of claim 2, wherein the indexing ring comprises an annular body having a plurality of outwardly extending tabs configured to engage corresponding retainer openings formed in the threaded collar.

4. The compensation fastener assembly of claim 2, wherein the indexing ring comprises a plurality of inwardly extending indexing detents configured to engage the leading end of the threaded insert.

5. The compensation fastener assembly of claim 4, wherein the indexing detents selectively engage portions of the leading end during rotation of the threaded insert relative to the threaded collar.

6. The compensation fastener assembly of claim 1, wherein the leading end of the threaded insert defines a plurality of corners and a plurality of flat regions arranged circumferentially about the central longitudinal axis.

7. The compensation fastener assembly of claim 6, wherein the indexing feature is configured to engage the flat regions to define the indexed rotational positions.

8. The compensation fastener assembly of claim 4, wherein each indexing detent includes a first leg and a second leg, the second leg being steeper than the first leg and configured to resist counter-rotation of the threaded insert relative to the threaded collar.

9. The compensation fastener assembly of claim 1, wherein the indexing feature comprises a resilient finger formed from the threaded collar and extending inwardly toward the central longitudinal axis to engage the leading end of the threaded insert.

10. A threaded fastener assembly comprising cooperating threaded components, comprising:
a first threaded component;
a second threaded component threadably engaged with the first threaded component such that relative rotation between the first threaded component and the second threaded component produces axial movement between the components; and
a rotational indexing interface disposed between the first threaded component and the second threaded component,
wherein the rotational indexing interface includes at least one resilient indexing element and at least one cooperating engagement surface defined by one of the threaded components,
wherein the indexing element is configured to elastically deflect during relative rotation of the threaded components and to engage the cooperating engagement surface to establish a plurality of discrete rotational positions between the threaded components, and
wherein engagement between the indexing element and the cooperating engagement surface resists unintended relative rotation between the threaded components.

11. The threaded fastener assembly of claim 10, wherein the rotational indexing interface includes a ring positioned between the threaded components.

12. The threaded fastener assembly of claim 10, wherein the indexing element comprises a detent configured to engage alternating corner regions and flat regions defined by the cooperating engagement surface.

13. The threaded fastener assembly of claim 10, wherein the indexing element comprises a resilient finger integrally formed from one of the threaded components.

14. The threaded fastener assembly of claim 10, wherein the cooperating engagement surface defines a polygonal perimeter.

15. The threaded fastener assembly of claim 14, wherein the polygonal perimeter is selected from a triangular profile, a square profile, or a hexagonal profile.

16. The threaded fastener assembly of claim 10, wherein the cooperating engagement surface defines an oval perimeter configured to provide two indexed rotational positions during a complete rotation.

17. A fastener-retaining system, comprising:
a first component;
a second component;
a fastener configured to extend through the first component toward the second component; and
the compensation fastener assembly of claim 1 positioned adjacent the first component and configured to receive the fastener,
wherein the compensation fastener assembly is adjustable in height through rotation of the threaded insert relative to the threaded collar, and
wherein the indexing feature maintains the threaded insert in a selected axial position relative to the threaded collar prior to installation of the fastener.

18. The fastener-retaining system of claim 17, further comprising a spring clip positioned within a sleeve through-hole of the threaded insert.

19. The fastener-retaining system of claim 18, wherein the spring clip includes resilient tabs configured to frictionally retain the fastener within the compensation fastener assembly.

20. The fastener-retaining system of claim 17, wherein the threaded collar includes at least one resilient leg configured to engage an opening formed in the first component.
